(19) United States
(12) Patent Application Publication
(10) Pub. No.: US 2015/0201105 A1
(43) Pub. Date: Jul. 16, 2015

(54) SYSTEMS AND METHODS FOR SECURE AND EFFICIENT DATA DELIVERY USING A PHYSICAL DOCUMENT

(71) Applicant: Google Inc., Mountain View, CA (US)

(72) Inventor: Ajay Nainani, Mountain View, CA (US)

(73) Assignee: Google Inc., Mountain View, CA (US)

(21) Appl. No.: 14/157,248

(22) Filed: Jan. 16, 2014

(51) Int. Cl. H04N 1/21; H04N 1/00

(52) U.S. Cl. CPC H04N 1/2166; H04N 1/0023

(57) ABSTRACT

Systems and methods for delivering data using a physical document are provided. Document data content associated with an electronic copy of a document is received at a computer system and stored in a database at a location defined by a location identifier. A machine-readable image is generated for application to a physical copy of the document and delivery to a document recipient. The machine-readable image identifies the location identifier and, in some implementations, a security credential for accessing the document data content in the database. The document recipient receives the physical copy of the document and obtains the location identifier and/or security credential by reading the machine-readable image from the physical copy of the document. The document recipient uses the location identifier and/or security credential to obtain the document data content electronically from the database.

### BACKGROUND

Many entities require the submission of paper forms and other non-electronic documents with a physical signature (e.g., a handwritten signature drawn on a physical copy of the document). For example, many government agencies utilize standard forms which require a handwritten physical signature. Such forms are typically printed copies of an electronic document which are signed by hand and then sent (e.g., mailed or faxed) to the intended recipient.

Sending a physical copy of a document to the intended recipient can cause several problems. For example, physical documents may contain sensitive data (e.g., bank account information, credit card information, social security numbers, personal identification information, etc.) that can be compromised upon interception of the document. Document recipients are often required to staff trustworthy individuals to perform repeated data entry and transcription tasks.

Due to many physical documents being handwritten, readability problems are common. Even on printed, typed forms, transcription errors can occur. Some processes which rely on the information contained in a physical document are significantly delayed by waiting for the data to arrive to internal systems by manual entry. It is difficult and challenging to efficiently and securely deliver data using a physical document.

### SUMMARY

One implementation of the present disclosure is a method for delivering data using a physical document. The method includes receiving, at a computer system, document data content associated with an electronic copy of a document; storing the document data content in a database at a location defined by a location identifier; and generating a machine-readable image for application to a physical copy of the document and delivery to a document recipient. The machine-readable image identifies the location identifier. The method further includes receiving a request for the document data content from the document recipient. The request includes the location identifier obtained from reading the machine-readable image from the physical copy of the document. The method further includes electronically delivering the document data content from the database to the document recipient in response to the request.

In some implementations, the method further includes restricting access to the document data content at the location using a security credential. The security credential may be required to access the document data content at the location. The machine-readable image may identify the location identifier and the security credential. The request for the document data content may include the security credential obtained from reading the machine-readable image from the physical copy of the document.

In some implementations, delivering the machine-readable image to the document recipient includes identifying a first security credential received from the document recipient and obtained from reading the machine-readable image from the physical copy of the document, comparing the first security credential with a second security credential maintained by the computer system for restricting access to the stored document data content, and retrieving the document data content from the location in response to the first security credential matching the second security credential.

In some implementations, the machine-readable image comprises at least one of a QR code, a bar code, a graphical image, and machine-readable text. In some implementations, the machine-readable image identifies the location at which the document data content is stored without reiterating the document data content in an encoded or non-encoded form. In some implementations, the machine-readable image is not a function of the document data content.

In some implementations, the physical copy of the document is created from the electronic copy of the document. In some implementations, the machine-readable image is applied to the physical copy of the document by printing the physical copy of the document in conjunction with the machine-readable image. In some implementations, the machine-readable image is delivered to the document recipient in conjunction with the physical copy of the document.

In some implementations, the method further includes replacing the document data in the electronic copy of the document with the machine-readable image prior to the physical copy of the document being created from the electronic copy of the document. The physical copy of the document may include the machine-readable image in place of the document data content.

In some implementations, delivering the machine-readable image to the document recipient comprises at least one of delivering the physical copy of the document to the document recipient, with the machine-readable image applied thereto, or creating a second electronic copy of the document from the physical copy of the document with the machine-readable image applied thereto and delivering the second electronic copy of the document to the document recipient.

Another implementation of the present disclosure is a system for delivering data using a physical document, the system includes a data delivery system configured to receive document data content associated with an electronic copy of a document, store the document data content in a database at a location defined by a location identifier, and generate a machine-readable image for application to a physical copy of the document and delivery to a document recipient. The machine-readable image may identify the location identifier. The data delivery system is further configured to receive a request for the document data content from the document recipient. The request may include the location identifier obtained from reading the machine-readable image from the physical copy of the document. The data delivery system is further configured to electronically deliver the document data content from the database to the document recipient in response to the request.

In some implementations, the data delivery system is further configured to restrict access to the document data content at the location using a security credential. The security credential may be required to access the document data content at the location. The machine-readable image may identify the location identifier and the security credential. The request for the document data content may include the security credential obtained from reading the machine-readable image from the physical copy of the document.

In some implementations, delivering the machine-readable image to the document recipient includes identifying a first security credential received from the document recipient and obtained from reading the machine-readable image from the physical copy of the document, comparing the first security credential with a second security credential maintained by the computer system for restricting access to the stored document data content, and retrieving the document data content from the location in response to the first security credential matching the second security credential.

In some implementations, wherein the machine-readable image comprises at least one of a QR code, a bar code, a graphical image, and machine-readable text. In some implementations, the machine-readable image identifies the location at which the document data content is stored without reiterating the document data content in an encoded or non-encoded form. In some implementations, the machine-readable image is not a function of the document data content.

In some implementations, the machine-readable image is applied to the physical copy of the document by printing the physical copy of the document in conjunction with the machine-readable image. In some implementations, the machine-readable image is delivered to the document recipient in conjunction with the physical copy of the document.

In some implementations, the data delivery system is further configured to replace the document data in the electronic copy of the document with the machine-readable image prior to the physical copy of the document being created from the electronic copy of the document. The physical copy of the document may include the machine-readable image in place of the document data content.

In some implementations, delivering the machine-readable image to the document recipient comprises at least one of delivering, to the document recipient, the physical copy of the document with the machine-readable image applied thereto; or creating a second electronic copy of the document from the physical copy of the document with the machine-readable image applied thereto and delivering the second electronic copy of the document to the document recipient.

Another implementation of the present disclosure is a system for delivering data using a physical document. The system includes a computer system configured to store, in a database, document data content received electronically from a first entity. The computer system is further configured to generate a machine-readable image comprising information for accessing the document data content in the database and to provide the machine-readable image to the first entity for application to a physical document. The computer system is further configured to receive a request for the document data content from a second entity. The request may include the information for accessing the document data content obtained from reading the machine-readable image from the physical document. The computer system is further configured to retrieve the document data content from the database and electronically deliver the document data content to the second entity in response to the request.

In some implementations, the information for accessing the document data content comprises at least one of a location identifier and a security credential. In some implementations, the machine-readable image comprises at least one of a QR code, a bar code, a graphical image, and machine-readable text. In some implementations, the machine-readable image is delivered to the second entity in conjunction with the physical document.

The foregoing is a summary and thus by necessity contains simplifications, generalizations, and omissions of detail. Consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a block diagram of a computer system for securely and efficiently delivering data using a physical document, shown to include resources, user devices, a data delivery system, data storage devices, and a document recipient, according to a described implementation.

FIG. 2 is a flow diagram illustrating a process for delivering document data content to a document recipient by storing the data electronically in a database and providing the document recipient with a physical document having a machine-readable image including information for accessing the document data content in the database, according to a described implementation.

FIG. 3 is a block diagram illustrating a configuration of the computer system of FIG. 1 in which the document recipient retrieves the document data content directly from the data storage devices, according to a described implementation.

FIG. 4 is a block diagram illustrating a configuration of the computer system of FIG. 1 in which the document recipient requests the document data content from the data delivery system and the data delivery system retrieves the document data content from the data storage devices, according to a described implementation.

FIG. 5 is a block diagram illustrating the data delivery system of FIG. 1 in greater detail, according to a described implementation.

FIG. 6 is a flowchart of a process for securely and efficiently delivering data using a physical document, according to a described implementation.

### DETAILED DESCRIPTION

Referring generally to the FIGURES, systems and methods for secure and efficient data delivery using a physical document are shown, according to a described implementation. The systems and methods described herein may be used to improve the efficiency and security of data delivery processes which require the use of a physical document (e.g., mail, fax, etc.). For example, the systems and methods of the present disclosure may expedite data delivery for processes which use paper forms, printed documents, and other types of physical documents.

In some implementations, the systems and methods described herein may be used to facilitate data delivery in conjunction with documents which require a physical signature (e.g., a handwritten signature drawn on a physical copy of the document). For example, an electronic copy of a document may be generated at a computer or other electronic device using information provided by a user. The document may be a text document, a web form, or any other type of document which includes data content. The document data content is sent to a computer system (e.g., via the Internet) and stored in a database at a location defined by a location identifier. The location identifier may include, for example, a name or location of a particular database, a specific row of the database, and/or any other indication of where document data content is stored. In some implementations, a security credential is required to access the document data content at the storage location.

A machine-readable image (e.g., a QR code, a bar code, machine-readable text, etc.) may be generated and applied to a physical copy of the document. For example, the machine-readable image may be printed in conjunction with the electronic copy of the document to create a physical copy of the document (e.g., a hard copy, a paper copy, etc.) which includes the machine-readable image. In some implementations, the machine-readable image includes an indication of the location identifier and/or the security credential. The information contained in the machine-readable image may allow the document data content to be located and retrieved from the location at which the document data content is stored.

In some implementations, the document data content is replaced at least partially with the machine-readable image in the physical copy of the document. Replacing the document data content with the machine-readable image may provide enhanced security for the document data content in the event that the physical copy of the document is lost or intercepted. The enhanced security may be useful for delivering sensitive or confidential information (e.g., bank account information, credit card information, social security numbers, medical records, etc.). In other implementations, the document data content may be retained and delivered in the physical copy of the document along with the machine-readable image. Retaining the document data content in the physical copy of the document may assure a user that the physical copy of the document that the user is signing includes accurate information.

The physical copy of the document may be signed and delivered to a document recipient. Upon receiving the physical copy of the document, the document recipient may scan or read the machine-readable image to obtain the location identifier and/or the security credential. The document recipient may retrieve the document data content from the storage location using the location identifier and/or the security credential. The document data content can be automatically copied or moved (e.g., electronically by a computer system) from the storage location into other tools or systems (e.g., processing or analysis systems operated by the document recipient) without requiring manual data entry and/or transcription.

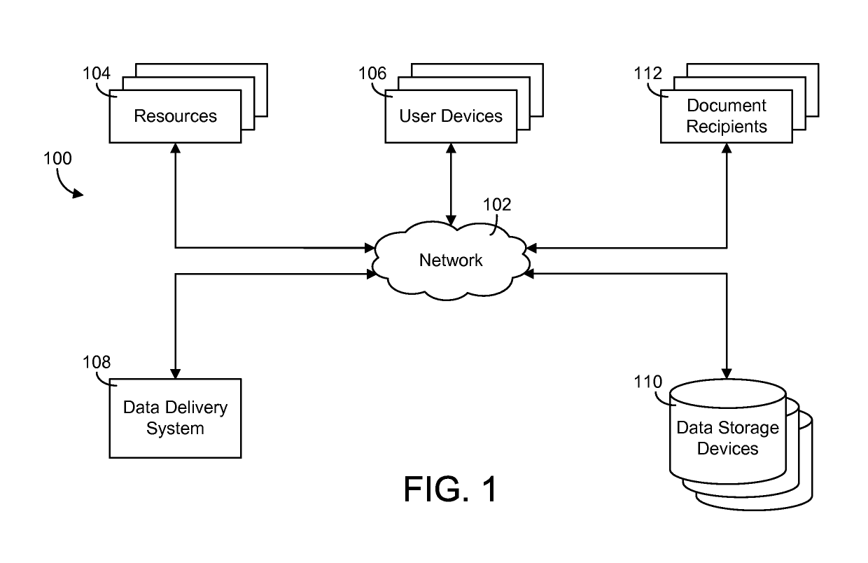

Referring now to FIG. 1, a block diagram of a computer system 100 is shown, according to a described implementation. Computer system 100 is shown to include a network 102, resources 104, user devices 106, a data delivery system 108, data storage devices 110, and document recipients 112. Computer system 100 may facilitate communication between resources 104, user devices 106, and data delivery system 108. For example, user devices 106 may retrieve and view resource content (e.g., webpages, electronic documents, web forms, etc.) from resources 104. The information obtained from resources 104 may prompt user devices 106 to submit document data content. For example, the resource content may prompt user devices 106 to complete an online form or to enter data into one or more form fields of an electronic document. User devices 106 may submit the document data content to resources 104, data delivery system 106, or data storage devices 110.

Computer system 100 may facilitate communication between data delivery system 108 and data storage devices 110. For example, in some implementations, data delivery system 108 receives the document data content provided by user devices 106. Data delivery system 108 may store the document data content in data storage devices 110 at a location defined by a location identifier. In some implementations, a security credential is required to access the document data content at the storage location. Data delivery system 108 may generate a machine-readable image (e.g., a QR code, a bar code, machine-readable text, etc.) based on the location identifier and/or the security credential. The machine-readable image may include the information required for accessing the document data content at data storage devices 110. Data delivery system 108 may provide the machine-readable image to user devices 106 via network 102.

Computer system 100 may facilitate communication between document recipients 112 and data storage devices 110. For example, document recipients 112 may receive a physical copy of the document from user devices 106 (e.g., by mail, by fax, by courier or other form of physical delivery, etc.). The physical copy of the document includes the machine-readable image generated by data delivery system 108. Document recipients 112 may read the machine-readable image to obtain the information required for accessing the document data content at data storage devices 110 (e.g., the location identifier and/or the security credential). Document recipients 112 may retrieve the document data content from data storage devices 110 via network 102.

Still referring to FIG. 1, computer system 100 is shown to include a network 102. Network 102 may be a local area network (LAN), a wide area network (WAN), a cellular network, a satellite network, a radio network, the Internet, or any other type of data network or combination thereof. Network 102 may include any number of computing devices (e.g., computers, servers, routers, network switches, etc.) configured to transmit, receive, or relay data. Network 102 may further include any number of hardwired and/or wireless connections. For example, user devices 108 may communicate wirelessly (e.g., via WiFi, cellular, radio, etc.) with a transceiver that is hardwired (e.g., via a fiber optic cable, a CAT5 cable, etc.) to a computing device of network 102.

Still referring to FIG. 1, computer system 100 is shown to include resources 104. Resources 104 may include any type of information or data structure that can be provided over network 102. In some implementations, resources 104 may be identified by a resource address associated with each resource (e.g., a resource URL) Resources 104 may include web pages (e.g., HTML web pages, PHP web pages, etc.), word processing documents, portable document format (PDF) documents, images, video, programming elements, interactive content, streaming video/audio sources, or other types of electronic information. Resources 104 may include content having embedded information (e.g., meta-information embedded in hyperlinks) and/or embedded instructions. Embedded instructions may include computer-readable instructions (e.g., software code, computer-readable script, HTML code, etc.) which are executed by user devices 106 (e.g., by a web browser running on user devices 106) upon viewing resource content.

Resources 104 may include template versions of electronic documents, webpages, and/or other types of electronic content. Resources 104 may prompt user devices 106 to submit document data content to complete the template versions of the documents. For example, resources 104 may include webpages or online forms which have one or more form fields into which user devices 106 can provide document data content. In some implementations, resources 104 include document files which can be downloaded by user devices 106 and completed in an offline environment. In some implementations, resources 104 prompt user devices 106 to submit document data content via an interface provided by resources 104 (e.g., a webpage, a web application, etc.). For example, resources 104 may prompt user devices 106 to enter data into a form field and/or to upload an electronic copy of a document. In various implementations, the document data content provided by user devices 106 may be sent to resources 104, data delivery system 108, and/or data storage devices 110. For implementations in which user devices 106 send document data content to resources 104, resources 104 may forward the document data content to data delivery system 108 and/or data storage devices 110.

In some implementations, resources 104 may be combined with document recipients 112. Resources 104 may include data stored on the one or more electronic devices (e.g., computers, servers, etc.) operated by document recipients 112. For example, document recipients 112 may operate a website through which various electronic documents can be viewed and downloaded by user devices 106. The electronic documents may include forms, word processing documents, PDF documents, or other types of electronic documents used or created by document recipients 112. For example, document recipients 112 may be a business or government entity which provides various forms via resources 104. In some implementations, resources 104 may be separate from document recipients 112. For example, resources 104 may include data stored on a remote server (e.g., FTP servers, file sharing servers, web servers, etc.), combinations of servers (e.g., data centers, cloud computing platforms, etc.), or other data storage devices separate from document recipients 112.

Still referring to FIG. 1, computer system 100 is shown to include user devices 106. User devices 106 may include any number and/or type of user-operable electronic devices. For example, user devices 106 may include desktop computers, laptop computers, smartphones, tablets, mobile communication devices, remote workstations, client terminals, entertainment consoles, or any other devices capable of interacting with the other components of computer system 100 (e.g., via a communications interface). For example, user devices 106 may be capable of receiving resource content from resources 104. User devices 106 may include mobile devices or non-mobile devices.

In some implementations, user devices 106 include an application (e.g., a web browser, a resource renderer, etc.) for converting electronic content into a user-comprehensible format (e.g., visual, aural, graphical, etc.). User devices 106 may include a user interface element (e.g., an electronic display, a speaker, a keyboard, a mouse, a microphone, a printer, etc.) for presenting content to a user, receiving user input, and/or facilitating user interaction with electronic content (e.g., clicking on a content item, hovering over a content item, etc.). User devices 106 may function as a user agent for viewing HTML encoded content. User devices 106 may include a processor capable of processing embedded information (e.g., meta information embedded in hyperlinks, etc.) and executing embedded instructions. Embedded instructions may include computer-readable instructions (e.g., software code, computer-readable script, HTML code, etc.) provided by resources 104 and/or data delivery system 108.

In some implementations, user devices 106 receive and execute instructions for generating the machine-readable image. Instructions for generating the machine-readable image may be provided to user devices 106 by data delivery system 108. For example, the instructions for generating the machine-readable image may be embedded within resources 104 and downloaded by user devices 106 along with other resource content. In other implementations, user devices 106 receive the machine-readable image from data delivery system 108 and/or resources 104. In various implementations, the machine-readable image may be generated by data delivery system 108, resources 104, or user devices 106.

User devices 106 may create a simplified version of an electronic document by replacing some or all of the document data content with the machine-readable image. The machine-readable image may supplement or replace the document data content in simplified version of the document. In some implementations, user devices 106 create a version of the electronic document which includes both the document data content and the machine-readable image (i.e., without removing the document data content from the document or replacing the document data content with the machine readable image).

User devices 106 may be configured to create a physical copy of a document from an electronic copy of the document. For example, user devices 106 may include a printer, copier, fax machine, or other device for generating a physical copy (e.g., a hard copy, a paper copy, a printed copy, etc.) of an electronic document. In some implementations, user devices 106 combine the machine-readable image with some or all of the document data content to create the physical copy of the document. For example, user devices 106 may print the simplified or original version of the electronic document in conjunction with the machine-readable image to create the physical copy of the document. The physical copy of the document may be mailed, faxed, transported, or otherwise delivered (e.g., physically or electronically) to document recipients 112.

Still referring to FIG. 1, computer system 100 is shown to include a data delivery system 108. Data delivery system 108 may be configured to facilitate secure and efficient data delivery from user devices 106 to document recipients 112. Data delivery system 108 may receive document data content associated with an electronic copy of a document. The document data content may be received from user devices 106, resources 104, or other data sources. Data delivery system 108 may store the document data content in data storage devices 110 at a location defined by a location identifier. Access to the data in data storage devices 110 may be restricted by a security credential. Data delivery system 108 may communicate with data storage devices 110 to determine the location at which the document data content is stored and the security credential for accessing the document data content.

Data delivery system 108 may generate a machine-readable image using the location identifier and/or the document data content. In various implementations, the machine-readable image may identify one or both of the location identifier and the security credential. Data delivery system 108 may provide the machine-readable image to user devices 106 for application to a physical copy of an electronic document. In some implementations, data delivery system 108 creates a new version of the electronic document which includes the machine-readable image. In other implementations, user devices 106 create the new version of the electronic document. The machine-readable image may replace some, all, or none of the document data content provided to data delivery system 108.

In some implementations, data delivery system 108 receives a request for document data content from document recipients 112. The request for document data content may include the location identifier and/or security credential obtained from reading the machine-readable image from the physical copy of the document. For example, document recipients 112 may scan the machine-readable image upon receiving the physical copy of the document to obtain the location identifier and/or the security credential. Data delivery system 108 may use the location identifier and/or security credential to obtain the document data content from data storage devices 110 and deliver the document data content electronically (e.g., via network 102) to document recipients 112. In some implementations, document recipients retrieve the document data content directly from data storage devices 110 (e.g., without using data delivery system 108 as an intermediary).

Still referring to FIG. 1, computer system 100 is shown to include data storage devices 110. Data storage devices 110 may be any type of memory device capable of storing document data content provided by user devices 106 and/or data delivery system 108. Data storage devices 110 may include any type of non-volatile memory, media, or memory devices. For example, data storage devices 110 may include semiconductor memory devices (e.g., EPROM, EEPROM, flash memory devices, etc.) magnetic disks (e.g., internal hard disks, removable disks, etc.), magneto-optical disks, and/or CD-ROM and DVD-ROM disks.

In some implementations, data storage devices 110 may be local to user devices 106, document recipients 112, and/or data delivery system 110. In other implementations, data storage devices 110 may be remote data storage devices connected with data delivery system 108 and/or document recipients 112 via network 102. In some implementations, data storage devices 110 may be part of a data storage server or system capable of receiving and responding to queries from data delivery system 108 and/or document recipients 112.

Data storage devices 110 may be configured to store the document data content provided by user devices 106. In various implementations, data storage devices 110 receive the document data content from data delivery system 108, resources 104, or directly from user devices 106. Document data content may include, for example, text data, form field data, user profile data, financial data, or other data collected from user devices 106. Document data content may be provided by user devices 106 or from another data source. For example, user devices 106 may be associated with profile data (e.g., behavioral data, location data, online/offline activity data, user interest data, etc.) and/or account data (e.g., credit card numbers, phone numbers, bank account numbers, etc.) maintained by data delivery system 108, resources 104, or a separate computer system. Data delivery system 108 may add the profile data and/or account data to the document data content and store the combined data in data storage devices 110.

For situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated (e.g., by data delivery system 108) in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, a user may have control over how information is collected (e.g., by an application, by user devices 106, etc.) and used by data delivery system 108. In some implementations, content providers may be provided with similar control options regarding the collection and use of content provider data (e.g., data associated with particular content providers, data extracted from a resource, etc.).

In some implementations, data storage devices 110 store document data content which includes sensitive or confidential information (e.g., bank account information, credit card information, social security numbers, medical records, etc.). The document data content may be stored at a particular location within data storage devices 110 (e.g., a specific database, a unique row of a database, etc.) and protected by a security credential (e.g., a password, a security key, etc.). The location within data storage devices 110 at which the document data content is stored may be defined by a location identifier. The location identifier may include, for example, a uniform resource identifier, a name or location of a particular database, a unique row ID, and/or other information used to locate the stored document data content. Access to the document data content in data storage devices 110 may be restricted by knowledge of the security credential.

Data storage devices 110 may communicate the location identifier and/or the security credential to data delivery system 108, resources 104, and/or user devices 106. The location identifier and/or security credential may be used to generate the machine-readable image. The machine-readable image may be applied to a printed copy of the document and sent to document recipients 112.

Still referring to FIG. 1, computer system 100 is shown to include document recipients 112. Document recipients 112 may receive a physical copy of a document from user devices 106. For example, document recipients 112 may receive the physical copy of the document by mail, by fax, by courier, by physical delivery, or by any other delivery process which produces a physical document (e.g., downloading an electronic copy of the document and printing the electronic copy to produce a physical copy, etc.).

Document recipients 112 may scan or read the machine-readable image to obtain the location identifier and/or the security credential. Document recipients 112 may use the location identifier and/or security credential obtained from the machine-readable image to retrieve the document data content from data storage devices 110. Document recipients 112 may copy or move the document data content to another database (e.g., a database controlled by document recipients 112), or another system or process for subsequent data analysis and/or processing. Retrieving the document data content from data storage devices 110 can be automated (e.g., performed partially or entirely by a computer system), thereby minimizing the potential for transcription errors and reducing the exposure of potentially sensitive or confidential information.

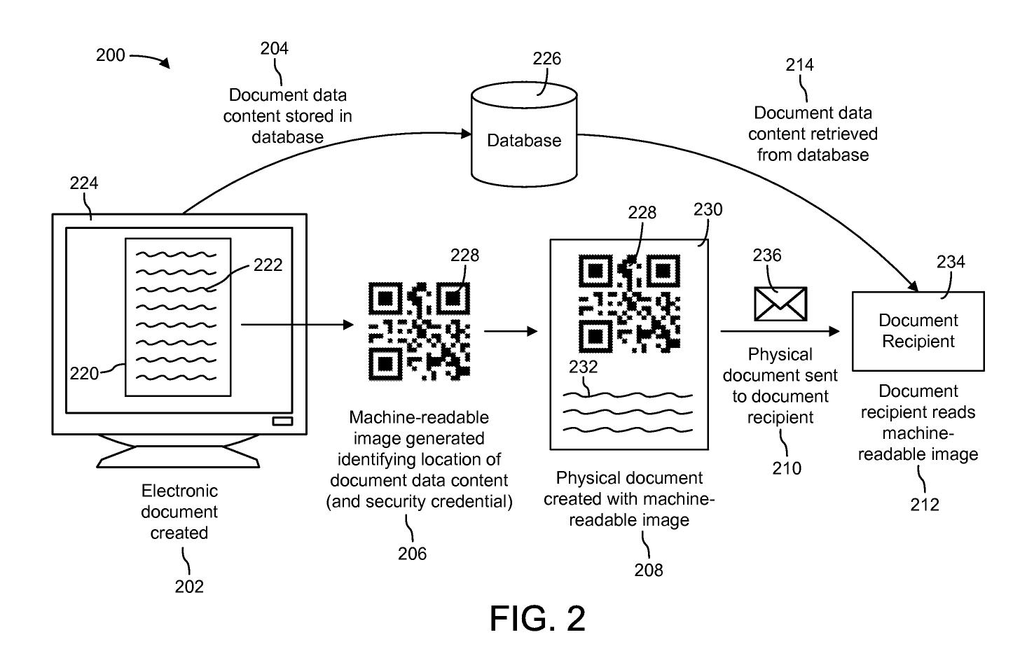

Referring now to FIG. 2, a flow diagram illustrating a process 200 for efficient and secure data delivery is shown, according to a described implementation. Process 200 may be performed by one or more components of computer system 100, as described with reference to FIG. 1.

Process 200 is shown to include creating an electronic document 220 (step 202). Electronic document 220 may be a webpage, an online form, a word processing document, a PDF document, a template document, or any other type of electronic document. Electronic document 220 may be displayed, for example, on a computer monitor 224. Computer monitor 224 may be a display of user devices 106 for viewing electronic document 220.

Electronic document 220 is shown to include document data content 222. Document data content 222 may include data entered into electronic document 220. In some implementations, document data content 222 includes user-provided data entered into form fields of a webpage or online form. In some implementations, document data content 222 may be generated in an offline environment using a word processing application, PDF viewer application, or other application for adding document data content 222 to electronic document 220.

Still referring to FIG. 2, process 200 is shown to include storing document data content 222 in a database 226 (step 204). Database 226 may be located within data storage devices 110, as described with reference to FIG. 1. Document data content 222 may be extracted from electronic document 220 and sent electronically to database 226 (e.g., via network 102). Step 204 may include storing document data content 222 at a location in database 226 defined by a location identifier (e.g., a unique row ID, a URL, a database location, etc.). In some implementations, access to document data content 222 in database 226 is restricted by knowledge of a security credential.

Still referring to FIG. 2, process 200 is shown to include generating a machine-readable image 228 (step 206). Machine-readable image 228 may be a QR code, bar code, machine-readable text, graphical image, or any other machine-readable image which can be applied to a physical document. In various implementations, machine-readable image 228 may be generated by data delivery system 108, data storage devices 110, or user devices 106. The location identifier and/or the security credential may be used to generate machine-readable image 228. In other words, machine-readable image 228 may be a function of the location identifier and/or the security credential. Machine readable image 228 can be read or scanned to obtain the location identifier and/or the security credential.

Still referring to FIG. 2, process 200 is shown to include creating a physical document 230 (step 208). Physical document 230 is shown to include machine-readable image 228. In some implementations, step 208 includes printing machine-readable image 228 in conjunction with electronic document 220 to generate a physical document 230 which includes machine-readable image 228. Machine-readable image 228 may supplement or replace document data content 222 in physical document 230. As shown in FIG. 2, physical document 230 may include some content 232 which is not replaced by machine-readable image 228. Content 232 may include, for example, a line for a physical signature, a document header, a document identifier, or other information not removed from physical document 230. In various implementations, content 232 may repeat some, all, or none of document data content 222.

Still referring to FIG. 2, process 200 is shown to include sending physical document 230 to a document recipient 234 (step 210). Document recipient 234 may be the same or similar to document recipient 112 as described with reference to FIG. 1. Step 210 may include mailing (illustrated by mail icon 236), faxing, transporting, or otherwise delivering a physical copy of document 230 to document recipient 234. The copy of physical document 230 delivered to document recipient 234 may be the same or different than the original physical document 230 created from electronic document 220. For example, physical document 230 may be scanned or faxed and a second physical copy may be printed from the scanned or faxed image. The second physical copy may be delivered to document recipient 234.

Still referring to FIG. 2, process 200 is shown to include reading machine-readable image 228 (step 212) and retrieving document data content 222 from database 226 (step 214). Step 212 may be performed by document recipient 234 upon receiving physical document 230. Machine-readable image 228 may be read, scanned, or otherwise processed to obtain the location identifier and/or the security credential. In step 214, document recipient 234 may submit a request document data content 222 stored in database 226. The request may include an indication of the location identifier and/or the security credential.

In various implementations, document recipient 234 may request document data content 222 directly from data storage devices 110 or indirectly via data delivery system 108. For example, data delivery system 108 may receive a request for document data content 222 from document recipient 234 and retrieve document data content 222 from data storage devices 110 in response to the request. Data delivery system may then provide document data content 222 to document recipient 234.

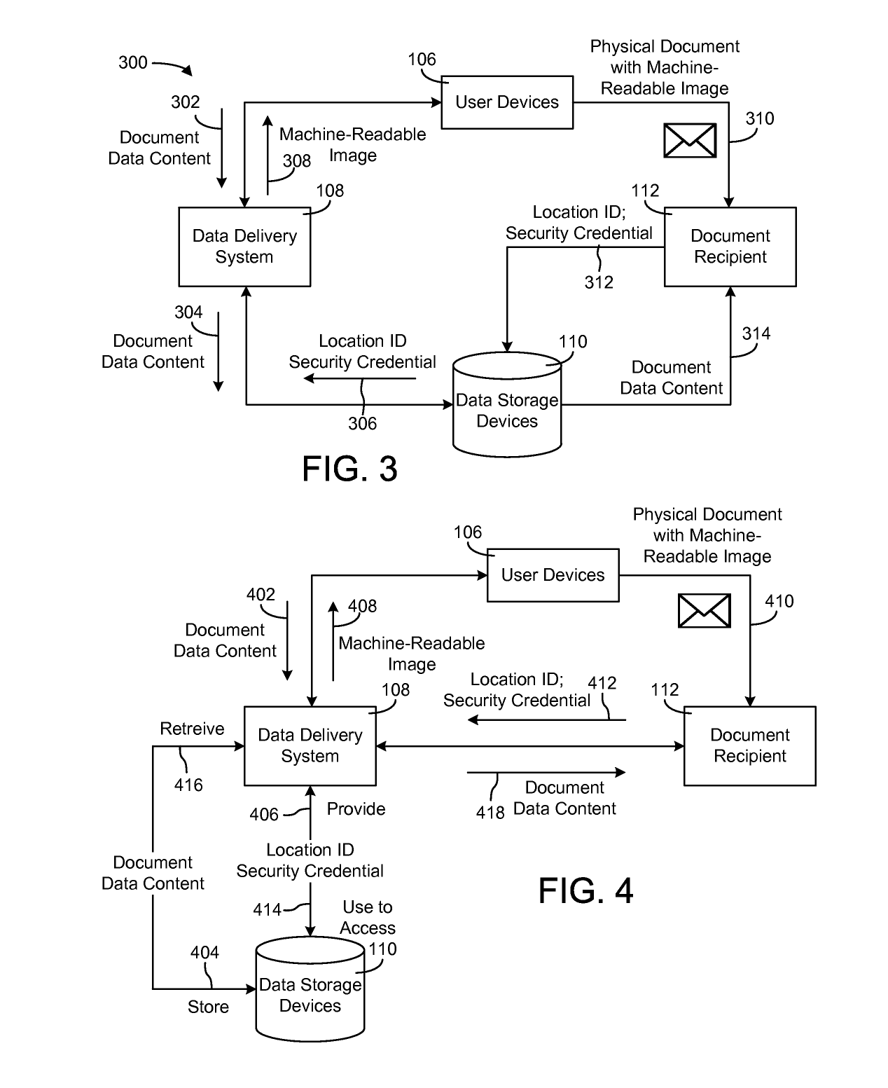

Referring now to FIG. 3, a block diagram illustrating a process 300 for secure and efficient data delivery using a physical document is shown, according to a described implementation. Process 300 may be performed by one or more components of computer system 100. For example, FIG. 3 is shown to include user devices 106, data delivery system 108, data storage devices 110, and document recipient 112.

In process 300, data delivery system 108 receives document data content from user devices 106 (step 302) and stores the document data content in data storage devices 110 (step 304). The document data content may include data entered into an electronic document such as a webpage or online form. In some implementations, the document data content may be generated in an offline environment using a word processing application, PDF viewer application, or other application for adding document data content to an electronic document. In some implementations, data delivery system 108 stores the document data content at a particular location within data storage devices 110 defined by a location identifier. Access to the document data content in data storage devices 110 may be restricted by knowledge of a security credential.

Still referring to FIG. 3, data storage devices 110 may provide the location identifier and security credential to data delivery system 108 upon storing the document data content (step 306). Data delivery system 108 may generate a machine-readable image (e.g., machine readable image 228) based on the location identifier and the security credential. In some implementations, data delivery system 108 generates a new electronic document which includes the machine-readable image. In other implementations, data delivery system 108 provides the machine-readable image to user devices 106 (step 308) and user devices 106 apply the machine-readable image to the electronic document. The machine-readable image may replace some, all, or none of the document data content in the electronic document.

User devices 106 may generate a physical document (e.g., physical document 230) which includes the machine-readable image. The physical document with the machine-readable image may be generated, for example, by printing the electronic document in conjunction with the machine-readable image. User devices 106 may send the physical document with the machine-readable image to document recipient 112 (step 310). Document recipient 112 may use the machine-readable image to obtain the location identifier and the security credential.

Still referring to FIG. 3, in process 300, document recipient 112 requests the document data content from data storage devices 110 (step 312). The request may include an indication of the location identifier and the security credential. Data storage devices 110 may respond to the request by allowing access to the document data content (e.g., if the correct security credential and location identifier are provided in step 312) and/or delivering the document data content to document recipient 112 (step 314).

Referring now to FIG. 4, a block diagram illustrating another process 400 for secure and efficient data delivery using a physical document is shown, according to a described implementation. Process 400 is similar to process 300 and may be performed by one or more components of computer system 100. For example, FIG. 4 is shown to include user devices 106, data delivery system 108, data storage devices 110, and document recipient 112.

In process 400, steps 402-410 may be the same or similar to steps 302-310, as described with reference to FIG. 3. For example, user devices 106 may provide document data content to data delivery system 108 (step 402) and data delivery system 108 may store the document data content in data storage devices 110 (step 404). Data storage devices 110 may provide data delivery system 108 with a location identifier and a security credential for accessing the document data content in data storage devices 110 (step 406). Data delivery system 108 may generate a machine-readable image using the location identifier and the security credential and provide the machine-readable image to user devices 106 (step 408). User devices 106 may apply the machine-readable image to a physical copy of the document (e.g., by printing an electronic copy of the document in conjunction with the machine-readable image) and send (e.g., mail, fax, etc.) the physical copy of the document with the machine-readable image to document recipient 112 (step 410).

Still referring to FIG. 4, in process 400, document recipient 112 may communicate with data delivery system 108 (rather than with data storage devices 110, as described with reference to FIG. 3). For example, document recipient 112 may submit a request for the document data content to data delivery system 108 (step 412). The request may include an indication of the location identifier and the security credential. Data delivery system 108 may use the location identifier and the security credential to access the document data content in data storage devices 110 (step 414). Data delivery system 108 may retrieve the document data content from data storage devices 110 (step 416) and provide the document data content to document recipient 112 (step 418).

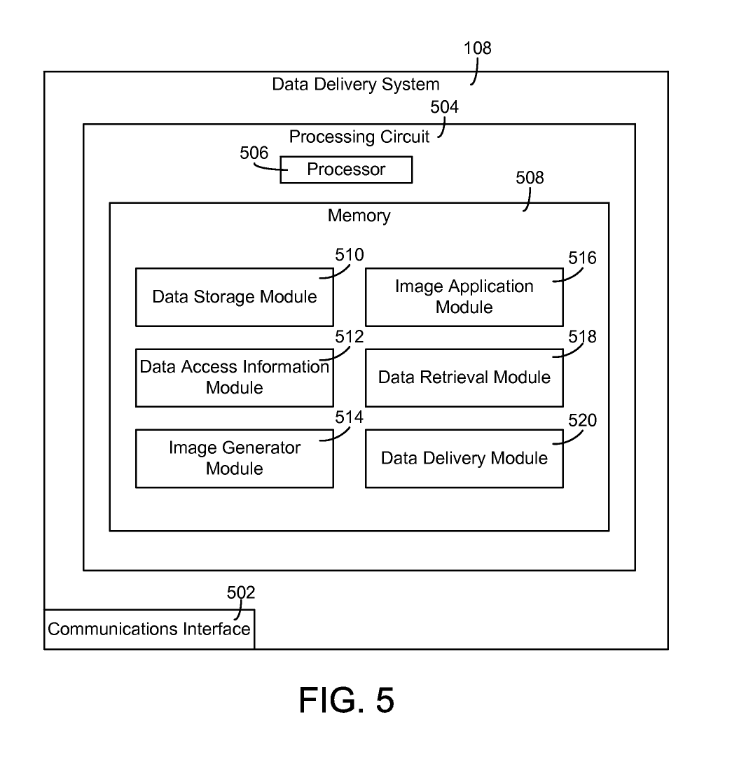

Referring now to FIG. 5, a block diagram illustrating data delivery system 108 in greater detail is shown, according to a described implementation. Data delivery system 108 is shown to include a communications interface 502 and a processing circuit 504. Communications interface 502 may include wired or wireless interfaces (e.g., jacks, antennas, transmitters, receivers, transceivers, wire terminals, Ethernet ports, WiFi transceivers, etc.) for conducting data communications with local or remote devices or systems. For example, communications interface 502 may allow data delivery system 108 to communicate with network 102, resources 104, user devices 106, and data storage devices 110.

In some implementations, communications interface 502 receives document data content associated with an electronic copy of a document. For example, communications interface 502 may receive document data content associated with a webpage, an online form, a word processing document, a PDF document, a template document, or any other type of electronic document. Document data content may include text data, image data, graphical data, visual data, or any other type of data which may be found within the data content of an electronic document. In some implementations, document data content includes user-provided data entered into form fields of a webpage or an online form. In some implementations, document data content may be generated in an offline environment using a word processing application, PDF application, or other application for adding document data content to an electronic copy of a document.

In some implementations, communications interface 502 receives document data content from user devices 106. For example, user devices 106 may submit the document data content to data delivery system 108 using a web browser application executing on user devices 106. In other implementations, communications interface 502 receives document data content from resources 104. User devices 106 may provide document data content to a website or other online resource (e.g., by submitting an online form, by uploading a document, etc.). Resources 104 may relay the document data content from user devices 106 to data delivery system 108. Communications interface 502 may receive the document data content directly from resources 104 and/or user devices 106 or via one or more intermediary components (e.g., components of network 102).

Still referring to FIG. 5, processing circuit 504 is shown to include a processor 506 and memory 508. Processor 506 may be implemented as a general purpose processor, an application specific integrated circuit (ASIC), one or more field programmable gate arrays (FPGAs), a CPU, a GPU, a group of processing components, or other suitable electronic processing components.

Memory 508 may include one or more devices (e.g., RAM, ROM, flash memory, hard disk storage, etc.) for storing data and/or computer code for completing and/or facilitating the various processes, layers, and modules described in the present disclosure. Memory 508 may comprise volatile memory or non-volatile memory. Memory 508 may include database components, object code components, script components, or any other type of information structure for supporting the various activities and information structures described in the present disclosure. In some implementations, memory 508 is communicably connected to processor 506 via processing circuit 504 and includes computer code (e.g., data modules stored in memory 508) for executing one or more processes described herein. In brief overview, memory 508 is shown to include a data storage module 510, a data access information module 512, an image generator module 514, a document creation module 516, a data retrieval module 518, and a data delivery module 520.

Still referring to FIG. 5, memory 500 is shown to include a data storage module 510. Data storage module 510 may be configured to store the document data content received at communications interface 502. In various implementations, data storage module 510 stores the document data content remotely (e.g., in data storage devices 110) or locally (e.g., in memory 508). Data storage module 510 may store the document data content at a location defined by a location identifier. The location identifier may include, for example, a uniform resource locator, a database name or location, and/or a row ID identifying a particular row of a database. The location identifier may include any information required to locate the document data content.

In some implementations, data storage module 510 stores the document data content according to the electronic document with which the document data content is associated. For example, data delivery system 108 may receive document data content associated with multiple different electronic documents (e.g., different webpages, different online forms, different word processing documents, etc.). Data storage module 510 may identify the electronic document associated with the document data content and store the document data content accordingly. For example, data storage module 510 may store a first set of document data content associated with a particular webpage in a first database. The first set of document data content may be received from multiple user devices 106 that provide information to the particular webpage. Data storage module 510 may store a second set of document data content associated with a particular online form in a second database. The second set of document data content may be received from multiple user devices 106 that provide information to the particular online form.

Data storage module 510 may store document data content provided by different user devices 106 in different rows of a database. The row in which the document data content is stored may be defined by a row ID. Each row ID may correspond to a different user, a different user device, a different online session, or other identifiable distinction between document data content provided by various user devices 106.

Still referring to FIG. 5, memory 500 is shown to include a data access information module 512. Data access information module 512 may be configured to generate or receive information for accessing the document data content at the storage location. Information for accessing the document data content at the storage location may include, for example, the location identifier defining the location of the document data content and/or a security credential. In some implementations, a security credential may be used to restrict access to the document data content. For example, the security credential may be required to access the document data content at the storage location. The security credential may include, for example, a password, a security key, a user name, a text string, a validation key, or other type of security credential. The security credential may be a public or private security key. In some implementations, a security credential may not be required to access the document data content. For implementations in which a security credential is not required, the information for accessing the document data content may include only a location identifier.

In some implementations, data access information module 512 receives the data access information (i.e., the location identifier and/or the security credential) from data storage devices 110. For example, data storage devices 110 may store the document data content at a particular location and provide data delivery system 108 with a location identifier for locating the document data content at the storage location. For implementations in which a security credential is required, data storage devices 110 may also provide data delivery system 108 with the security credential. In other implementations, the security credential may be generated by data access information module 512.

In some implementations, data access information module 512 may generate the data access information and store the document data content accordingly. For example, data access information module 512 may provide data storage devices 110 with a location identifier defining a location at which to store the document data content. The data access information may be provided entirely by data storage devices, entirely by data access information module 512, or partially by both data storage devices 110 and data access information module 512. For example, data access information module 512 may provide data storage devices 110 with a database name or location at which to store the document data content. Data storage devices 110 may store the document data content at an available row of the specified database and provide data access information module 512 with a row ID to further define the storage location. Data access information module 512 may provide the data access information to image generator module 514 for generating a machine-readable image.

Still referring to FIG. 5, memory 500 is shown to include an image generator module 514. Image generator module 514 may be configured to generate a machine-readable image using the data access information (e.g., a location identifier and/or a security credential) provided by data access information module 512. In various implementations, image generator module 514 generates a QR code, a bar code, machine-readable text, a graphical image, or any other type of visual indication or marking which can be applied to a physical copy of a document.

Image generator module 514 may generate a machine-readable image which includes the information required to access the document data content stored at data storage devices 110. For example, image generator module 514 may generate a machine-readable image which includes the location identifier and/or the security credential in an encoded or non-encoded form. In addition to the location identifier and/or the security credential, the machine-readable image may include other information pertaining to the document data content stored in data storage devices 110. For example, the machine-readable image may include an indication of the electronic document (e.g., a particular webpage, a particular online form, etc.) from which the document data content was obtained. Such additional information may be used by document recipients 112 to assist in classifying and storing the document data content when the document data content is delivered from data storage devices 110.

In some implementations, image generator module 514 generates a machine-readable image which includes only the location identifier and/or the security credential (e.g., in an encoded or non-encoded form). For example, the machine-readable image may include information for accessing the document data content in data storage devices 110 without reiterating or repeating the document data content. In some implementations, the machine-readable image is not a function of the document data content itself, but rather provides information for accessing the document data content in data storage devices 110. Image generator module 514 may generate the machine-readable image without regard to the document data content. For example, the machine-readable image may identify a location at which the document data content is stored regardless of the value or content of the document data at the storage location. The machine-readable image can be scanned or read to obtain the location identifier and/or the security credential.

Still referring to FIG. 5, memory 500 is shown to include an image application module 516. Image application module 516 may be configured to apply the machine-readable image to the electronic document. For example, image application module 516 may insert, append, overlay, adjoin, or otherwise integrate the machine-readable image with an electronic copy of the document. In some implementations, image application module 516 replaces some or all of the document data content in the electronic document with the machine-readable image. In other implementations, image application module 516 applies the machine-readable image to the electronic document without replacing or removing the document data content.

In some implementations, image application module 516 sends the machine-readable image to user devices 106 for application to a physical copy of the document. The physical copy of the document may be created from the electronic copy of the document and may include the machine-readable image. For example, applying the machine-readable image to a physical copy of the document may include printing the physical copy of the document in conjunction with the machine-readable image. In various implementations, the machine-readable image may be applied to the electronic copy of the document by data delivery system 108, user devices 106, or resources 104.

The machine-readable image may be delivered to document recipient 112 in conjunction with the physical copy of the document. Document recipient 112 may scan or read the machine-readable image to obtain the location identifier and/or the security credential. Document recipient 112 may use the location identifier and/or the security credential to retrieve or request the document data content from data storage devices 110.

Still referring to FIG. 5, memory 500 is shown to include a data retrieval module 518. Data retrieval module 518 may be used for implementations in which the document data content is retrieved from data storage devices 110 by data delivery system 108. Data retrieval module 518 may be configured to receive a request for the document data content from document recipient 112. The request may include the location identifier and/or the security credential obtained from reading the machine-readable image from the physical copy of the document. Data retrieval module 518 may use the location identifier and/or the security credential to retrieve the document data content from data storage devices 110.

In various implementations, access to the document data content in data storage devices 110 may be controlled by data storage devices 110 or data delivery system 108. For example, in some implementations, data storage devices 110 may require both a location identifier and a security credential to access the data stored therein. The security credential may be different for each row of data stored in data storage devices 110. In other implementations, data delivery system 108 manages the security credentials for data storage devices 110. For example, data retrieval module 518 may check whether a security credential provided by document recipient 112 matches the security credential for a particular row of data identified by the location identifier. If the security credentials match, data retrieval module 518 may retrieve the requested data from data storage devices 110. Data storage devices 110 may or may not require data retrieval module 518 to provide the security credential at the time the document data content is retrieved.

Still referring to FIG. 5, memory 500 is shown to include a data delivery module 520. Data delivery module 520 may be configured to deliver the requested document data content to document recipient 112. Data delivery module 520 may deliver the document data content to document recipient 112 electronically (e.g., via network 102). The electronic delivery of the document data content by data delivery module 520 may be partially or completely automated, thereby minimizing the potential for transcription errors and reducing the exposure of potentially sensitive or confidential information. Document recipients 112 may copy or move the document data content to another database (e.g., a database controlled by document recipients 112), or another system or process for subsequent data analysis and/or processing.

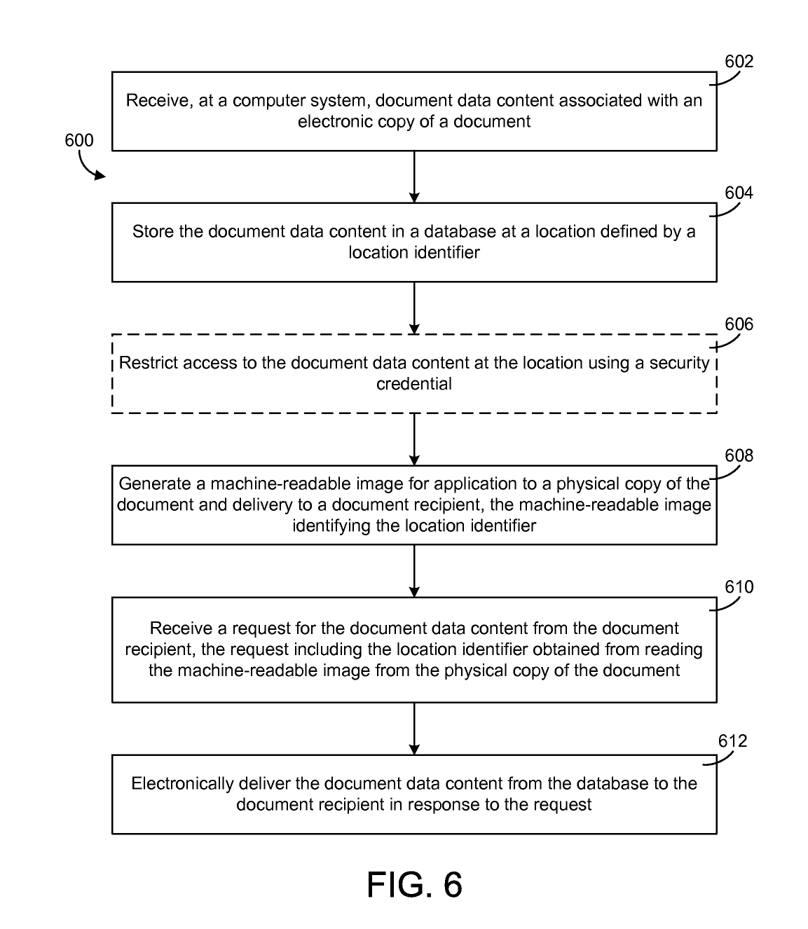

Referring now to FIG. 6, a flowchart of a process 600 for delivering data using a physical document is shown, according to a described implementation. Process 600 may be performed by data delivery system 108, as described with reference to FIGS. 1-5. In some implementations, process 600 is an automated process and may be performed with minimal or no human intervention.

Process 600 is shown to include receiving document data content associated with an electronic copy of a document (step 602). For example, step 602 may include receiving document data content associated with a webpage, an online form, a word processing document, a PDF document, a template document, or any other type of electronic document. Document data content may include text data, image data, graphical data, visual data, or any other type of data which may be found within the data content of an electronic document. In some implementations, document data content includes user-provided data entered into form fields of a webpage or an online form. In some implementations, document data content may be generated in an offline environment using a word processing application, PDF application, or other application for adding document data content to an electronic copy of a document.

In some implementations, step 602 includes receiving document data content from user devices 106. For example, user devices 106 may submit the document data content using a web browser application executing on user devices 106. In other implementations, step 602 includes receiving document data content from resources 104. For example, user devices 106 may provide document data content to a website or other online resource (e.g., by submitting an online form, by uploading a document, etc.). Resources 104 may relay the document data content from user devices 106 to data delivery system 108. Step 602 may include receiving the document data content directly from resources 104 and/or user devices 106 or via one or more intermediary components (e.g., components of network 102).

Still referring to FIG. 6, process 600 is shown to include storing the document data content in a database at a location defined by a location identifier (step 604). In various implementations, step 604 may include storing the document data content remotely (e.g., in data storage devices 110) or locally (e.g., in memory 508). The location identifier may include, for example, a uniform resource locator, a database name or location, and/or a row ID identifying a particular row of a database. The location identifier may include any information required to locate the document data content.

In some implementations, step 604 includes storing the document data content according to the electronic document with which the document data content is associated. For example, the document data content received in step 602 may include document data content associated with multiple different electronic documents (e.g., different webpages, different online forms, different word processing documents, etc.). Step 604 may include identifying the electronic document associated with the document data content and storing the document data content accordingly. For example, step 604 may include storing a first set of document data content associated with a particular webpage in a first database. The first set of document data content may be received from multiple user devices 106 that provide information to the particular webpage. Step 604 may include storing a second set of document data content associated with a particular online form in a second database. The second set of document data content may be received from multiple user devices 106 that provide information to the particular online form.

Step 604 may include storing document data content provided by different user devices 106 in different rows of a database. The row in which the document data content is stored may be defined by a row ID. Each row ID may correspond to a different user, a different user device, a different online session, or other identifiable distinction between document data content provided by various user devices 106.

Still referring to FIG. 6, process 600 is shown to include restricting access to the document data content at the location using a security credential (step 606). In some implementations, the security credential is required to access the document data content at the storage location in the database. The security credential may include, for example, a password, a security key, a user name, a text string, a validation key, or other type of security credential. The security credential may be a public or private security key.

In some implementations, step 606 includes generating or receiving information for accessing the document data content at the storage location. Information for accessing the document data content at the storage location may include, for example, the location identifier defining the location of the document data content and/or a security credential. In some implementations, a security credential may not be required to access the document data content. Step 606 is an optional step and may not be performed for implementations in which the document data content in the database is not secured or restricted. For implementations in which a security credential is not required, the information for accessing the document data content may include only a location identifier.

In some implementations, step 606 includes receiving the data access information (i.e., the location identifier and/or the security credential) from data storage devices 110. For example, data storage devices 110 may store the document data content at a particular location and provide data delivery system 108 with a location identifier for locating the document data content at the storage location. For implementations in which a security credential is required, data storage devices 110 may also provide data delivery system 108 with the security credential. In other implementations, step 606 includes generating the security credential (e.g., by data delivery system 108).

In various implementations, the data access information may be generated entirely by data storage devices 110, entirely by data delivery system 108, or partially by both data storage devices 110 and data delivery system 108. For example, data delivery system 108 may provide data storage devices 110 with a database name or location at which to store the document data content. Data storage devices 110 may store the document data content at an available row of the specified database and provide data delivery system 108 with a row ID to further define the storage location. In some implementations, step 606 includes storing or providing the location identifier and/or the security credential for use in generating a machine-readable image.

Still referring to FIG. 6, process 600 is shown to include generating a machine-readable image for application to a physical copy of the document and delivery to a document recipient (step 608). In various implementations, the machine-readable image generated in step 608 may be a QR code, a bar code, machine-readable text, a graphical image, or any other type of visual indication or marking which can be applied to a physical copy of a document.

Step 608 may include generating a machine-readable image which includes the information required to access the document data content stored in step 604. For example, step 608 may include generating a machine-readable image which includes the location identifier and/or the security credential in an encoded or non-encoded form. In other words, the machine-readable image may identify the location identifier and the security credential. Step 608 may include generating a machine-readable image using the location identifier and/or the security credential.

In some implementations, the machine-readable image may include other information pertaining to the document data content stored in step 604 in addition to the location identifier and/or the security credential. For example, the machine-readable image may include an indication of the electronic document (e.g., a particular webpage, a particular online form, etc.) from which the document data content was obtained. Such additional information may be used by document recipients 112 to assist in classifying and storing the document data content when the document data content is delivered from data storage devices 110.

In some implementations, step 608 includes generating a machine-readable image which includes only the location identifier and/or the security credential (e.g., in an encoded or non-encoded form). For example, the machine-readable image may include information for accessing the document data content in data storage devices 110 without reiterating or repeating the document data content. In some implementations, the machine-readable image is not a function of the document data content itself, but rather provides information for accessing the document data content in data storage devices 110. Step 608 may include generating the machine-readable image without regard to the document data content. For example, the machine-readable image may identify a location at which the document data content is stored regardless of the value or content of the document data at the storage location. The machine-readable image can be scanned or read to obtain the location identifier and/or the security credential.

In step 608, generating a machine-readable image for application to a physical copy of the document may include generating a machine-readable image which can be inserted, appended, overlaid, adjoined, or otherwise integrated with a physical copy of the document. In some implementations, applying the machine-readable image to the physical copy of the document includes printing the physical copy of the document in conjunction with the machine-readable image. The machine-readable image may replace some or all of the document data content in the physical copy of the document. In other implementations, the machine-readable image is applied to the physical copy of the document without replacing or removing the document data content.

In some implementations, applying the machine-readable image to a physical copy of the document includes applying the machine-readable image to an electronic copy of the document and subsequently creating a physical copy of the document from the electronic copy. The physical copy of the document may be created from the electronic copy of the document and may include the machine-readable image. In various implementations, the machine-readable image may be applied to the electronic copy of the document by data delivery system 108, user devices 106, or resources 104.

The machine-readable image may be delivered to document recipient 112 in conjunction with the physical copy of the document. Document recipient 112 may scan or read the machine-readable image to obtain the location identifier and/or the security credential. Document recipient 112 may use the location identifier and/or the security credential to retrieve or request the document data content from data storage devices 110.

Still referring to FIG. 6, process 600 is shown to include receiving a request for the document data content from the document recipient (step 610). The request may include the location identifier and/or the security credential obtained from reading the machine-readable image from the physical copy of the document.

Still referring to FIG. 6, process 600 is shown to include electronically delivering the document data content from the database to the document recipient in response to the request (step 612). In some implementations, step 612 includes using the location identifier and/or the security credential to retrieve the document data content from data storage devices 110. In various implementations, access to the document data content in data storage devices 110 may be controlled by data storage devices 110 or data delivery system 108. For example, in some implementations, data storage devices 110 may require both a location identifier and a security credential to access the data stored therein. The security credential may be different for each row of data stored in data storage devices 110. In other implementations, data delivery system 108 manages the security credentials for data storage devices 110.

In some implementations, step 612 includes checking whether a security credential provided by the document recipient matches the security credential for a particular row of data identified by the location identifier. If the security credentials match, step 612 may include retrieving the requested data from data storage devices 110. Data storage devices 110 may or may not a security credential at the time the document data content is retrieved.

Step 612 is shown to include delivering the document data content to the document recipient electronically (e.g., via network 102). The electronic delivery of the document data content by may be partially or completely automated, thereby minimizing the potential for transcription errors and reducing the exposure of potentially sensitive or confidential information. The document recipient may copy or move the document data content to another database (e.g., a database controlled by the document recipient), or another system or process for subsequent data analysis and/or processing.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

Implementations of the subject matter and the operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially-generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate components or media (e.g., multiple CDs, disks, or other storage devices). Accordingly, the computer storage medium is both tangible and non-transitory.

The operations described in this disclosure may be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application-specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD-ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front-end component (e.g., a client computer) having a graphical user interface or a web browser through which a user may interact with an implementation of the subject matter described in this disclosure, or any combination of one or more such back-end, middleware, or front-end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

While this specification contains many specific implementation details, these should not be construed as limitations on the scope of any disclosures or of what may be claimed, but rather as descriptions of features specific to particular implementations of particular disclosures. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products embodied on one or more tangible media.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming

1. A method for delivering data using a physical document, the method comprising:
receiving, at a computer system, document data content associated with an electronic copy of a document;
storing the document data content in a database at a location defined by a location identifier;
generating a machine-readable image for application to a physical copy of the document and delivery to a document recipient, the machine-readable image identifying the location identifier;
delivering the physical copy of the document with the machine-readable image to the document recipient, wherein the document recipient reads the machine-readable image from the physical copy of the document;
receiving, from the document recipient, a request for the document data content stored in the database, the request comprising the location identifier obtained from reading the machine-readable image from the physical copy of the document; and
electronically delivering the document data content from the database to the document recipient in response to the request.

2. The method of claim 1, further comprising:
restricting access to the document data content at the location using a security credential, wherein the security credential is required to access the document data content at the location;
wherein the machine-readable image identifies the location identifier and the security credential; and
wherein the request for the document data content includes the security credential obtained from reading the machine-readable image from the physical copy of the document.

3. The method of claim 1, wherein delivering the machine-readable image to the document recipient comprises:
identifying a first security credential received from the document recipient and obtained from reading the machine-readable image from the physical copy of the document;
comparing the first security credential with a second security credential maintained by the computer system for restricting access to the stored document data content; and
retrieving the document data content from the location in response to the first security credential matching the second security credential.

4. The method of claim 1, wherein the machine-readable image comprises at least one of a QR code, a bar code, a graphical image, and machine-readable text.

5. The method of claim 1, wherein the machine-readable image identifies the location at which the document data content is stored without reiterating the document data content in an encoded or non-encoded form.

6. The method of claim 1, wherein the machine-readable image is applied to the physical copy of the document by printing the physical copy of the document in conjunction with the machine-readable image.

7. The method of claim 1, further comprising:
replacing the document data in the electronic copy of the document with the machine-readable image prior to the physical copy of the document being created from the electronic copy of the document;
wherein the physical copy of the document comprises the machine-readable image in place of the document data content.

8. The method of claim 1, wherein the machine-readable image is delivered to the document recipient in conjunction with the physical copy of the document.

9. A system for delivering data using a physical document, the system comprising:
a data delivery system configured to:
receive document data content associated with an electronic copy of a document;
store the document data content in a database at a location defined by a location identifier;
generate a machine-readable image for application to a physical copy of the document and delivery to a document recipient, the machine-readable image identifying the location identifier;
deliver the physical copy of the document with the machine-readable image to the document recipient, wherein the document recipient reads the machine-readable image from the physical copy of the document;
receive, from the document recipient, a request for the document data content stored in the database, the request comprising the location identifier obtained from reading the machine-readable image from the physical copy of the document; and
electronically deliver the document data content from the database to the document recipient in response to the request.

10. The system of claim 9, wherein the data delivery system is further configured to:
restrict access to the document data content at the location using a security credential, wherein the security credential is required to access the document data content at the location;
wherein the machine-readable image identifies the location identifier and the security credential; and
wherein the request for the document data content includes the security credential obtained from reading the machine-readable image from the physical copy of the document.

11. The system of claim 9, delivering the machine-readable image to the document recipient comprises:
identifying a first security credential received from the document recipient and obtained from reading the machine-readable image from the physical copy of the document;
comparing the first security credential with a second security credential maintained by the computer system for restricting access to the stored document data content; and
retrieving the document data content from the location in response to the first security credential matching the second security credential.

12. The system of claim 9, wherein the machine-readable image comprises at least one of a QR code, a bar code, a graphical image, and machine-readable text.

13. The system of claim 9, wherein the machine-readable image identifies the location at which the document data content is stored without reiterating the document data content in an encoded or non-encoded form.

14. The system of claim 9, wherein the machine-readable image is applied to the physical copy of the document by printing the physical copy of the document in conjunction with the machine-readable image.

15. The system of claim 9, wherein the data delivery system is further configured to:
replace the document data in the electronic copy of the document with the machine-readable image prior to the physical copy of the document being created from the electronic copy of the document;
wherein the physical copy of the document comprises the machine-readable image in place of the document data content.

16. The system of claim 9, wherein the machine-readable image is delivered to the document recipient in conjunction with the physical copy of the document.

17. The system of claim 9, wherein delivering the machine-readable image to the document recipient comprises at least one of:
delivering, to the document recipient, the physical copy of the document with the machine-readable image applied thereto; and
creating a second electronic copy of the document from the physical copy of the document with the machine-readable image applied thereto and delivering the second electronic copy of the document to the document recipient.

18. A system for delivering data using a physical document, the system comprising:
a computer system configured to store, in a database, document data content received electronically from a first entity;
wherein the computer system is configured to generate a machine-readable image comprising information for accessing the document data content in the database and to provide the machine-readable image to the first entity for application to a physical document;
wherein the computer system is configured to cause delivery of the physical document with the machine-readable image to a second entity, wherein the second entity reads the machine-readable image from the physical document;
wherein the computer system is configured to receive, from the second entity, a request for the document data content stored in the database, the request comprising the information for accessing the document data content obtained from reading the machine-readable image from the physical document;
wherein the computer system is configured to retrieve the document data content from the database and electronically deliver the document data content to the second entity in response to the request.

19. The system of claim 18, wherein the information for accessing the document data content comprises at least one of a location identifier and a security credential.

20. The system of claim 18, wherein the machine-readable image comprises at least one of a QR code, a bar code, a graphical image, and machine-readable text; and
wherein the machine-readable image is delivered to the second entity in conjunction with the physical document.
